(19) United States
(12) Patent Application Publication
(10) Pub. No.: US 2017/0149925 A1
(43) Pub. Date: May 25, 2017

(54) PROCESSING CACHE DATA

(71) Applicant: EMC Corporation, Hopkinton, MA (US)

(72) Inventors: Lifeng Yang, Beijing (CN); Jian Gao, Beijing (CN); Xinlei Xu, Beijing (CN); Zhipeng Hu, Beijing (CN); Liam Xiongcheng Li, Beijing (CN)

(21) Appl. No.: 15/200,213

(22) Filed: Jul. 1, 2016

(30) Foreign Application Priority Data
Jun. 26, 2015 (CN) 2015103635190.0

(51) Int. Cl. H04L 29/08; H04L 12/24; H04L 12/26

(52) U.S. Cl. CPC H04L 67/2852; H04L 43/0817; H04L 41/069

(57) ABSTRACT

Embodiments of the present disclosure relate to a cache data processing apparatus, computer program product and a method by monitoring power supply statuses of a storage device to determine whether power failure occurs, and sending a power failure event to a processor of the storage device in response to determining that the power failure occurs such that the processor stops a data reading/writing operation of the storage device and flushes cache data to a disk

### RELATED APPLICATION

This application claim priority from Chinese Patent Application Number CN2015103635190.0, filed on Jun. 26, 2015 at the State Intellectual Property Office, China, titled “CACHE DATA PROCESSING METHOD AND APPARATUS,” the contents of which is herein incorporated by reference in entirety.

### DISCLAIMER

The Portions of this patent document/disclosure may contain command formats and other computer language listings, all of which are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the present disclosure relate to a data processing.

### BACKGROUND OF THE INVENTION

Generally, in the event of a power failure for a storage device, data in a cache may be lost. Usually, a battery power supply (e.g. a rechargeable battery) may be typically used as an emergency power supply to preserve or process data in a cache (i.e. dirty data). For example, in the event of a power failure, a storage device may flush cache data contained in the storage device (e.g. a memory) to a dedicated non-volatile storage area (e.g. a part of four blocks in the front of the disk, also called “small disk”) to protect data in a cache. A non-volatile storage area may be used to store temporarily a cache data that may not have been written to a disk. After power supply restores, a storage device may read cache data in a non-volatile storage area in order to write the cache data to a disk.

### SUMMARY OF THE INVENTION

Embodiments of the present disclosure provides a cache data processing apparatus, computer program product and a method by monitoring power supply statuses of a storage device to determine whether a power failure happens; and in response to determining that the power failure happens, sending the power failure event to a processor of the storage device such that the processor stops data reading/writing operations of the storage device and flushes the cache data to a disk.

### BRIEF DESCRIPTION OF THE DRAWINGS

Features, advantages and other aspects of the embodiments of the present disclosure will be more apparent with reference to the accompanying drawings and the following detailed description. Several embodiments of the present disclosure are presented herein in an exemplary and non-limiting manner. In the drawings:

FIG. 1 illustrates a flow diagram of the cache data processing method 100 according to one exemplary embodiments of the present disclosure.

FIG. 2 illustrates a block diagram of the intelligent platform management interface (IPMI) 200 according to one exemplary embodiments of the present disclosure.

FIG. 3 illustrates a block diagram of a system 300 of the storage device comprising two power sources according to one exemplary embodiments of the present disclosure.

FIG. 4 illustrates a flow diagram of the cache data processing method 400 according to one exemplary embodiments of the present disclosure.

FIG. 5 illustrates a block diagram of the cache data processing apparatus 500 according to one exemplary embodiments of the present disclosure.

FIG. 6 illustrates a block diagram of a system 600 in which the computer device according to one exemplary embodiments of the present disclosure may be implemented.

### DETAILED DESCRIPTION

Exemplary embodiments of the present disclosure are described in detail with reference to the accompanying drawings. The flow diagrams and the block diagrams in the drawings illustrate the architecture, function and operation that may be implemented with the method and system according to the embodiments of the present disclosure. It should be noted that each block in the flow diagram or block diagram may represent a module, a program segment, or a portion of code which may comprise one or more executable instructions or commands to implement the logic functions specified in the embodiments. It should also be noted that the functions marked in the blocks may also occur in an order different from that marked in the drawings in some alternative implementations. For example, two blocks shown successively can actually be implemented substantially in parallel or even be implemented in a reverse order depending on the function. It is also worth noted that each block in the flow diagram and/or block diagram and combination of the blocks in the flow diagram and/or block diagram may be implemented with the implementation specified function or operation-dedicated hardware-based system or a combination of a dedicated hardware and computer instructions.

It should also be understood that various terminology used herein is for the purpose of describing particular embodiments only and is not intended to be liming of the disclosure. The term “comprise”, “include” or similar terms used herein should be paraphrased as open terms, i.e., “comprise/include but not limited to”. The term “based on” indicates “based at least on”. The term “one embodiment” means “at least one embodiment”; and “another embodiment” represents “at least another embodiment”. As used herein, the singular forms “a”, “an” and “the” may include the plural forms, unless the context clearly indicates otherwise. It will be further understood that the terms “comprises”, “has” and “including” used herein, specify the presence of stated features, elements, and/or components etc., but do not preclude the presence of one or more other features, elements, components and/ or combinations thereof. For example, the term “multiple” used here indicates “two or more”; the term “and/or” used here may comprise any or all combinations of one or more of the items listed in parallel. Definitions of other terms will be specifically provided in the following description. Furthermore, in the following description, some functions or structures well-known to those skilled in the art will be omitted in order not to obscure embodiments of the disclosure in the unnecessary details.

In some embodiments, a current cache data processing method may only passively protects data in a cache and may not be configured to actively monitor a power supply status in a storage device and process data in the cache. In some other embodiments, when an external power supply of a storage device is switched off, a dedicated battery power supply may only provide power supply for a very limited amount of time, for example, 10-300 seconds. In some other embodiments, it may be sufficient for a disk array under many conditions; however, in some other embodiments, with an upgrade of a hardware platform, an increase of power supply loss and a growth in size of cache memory, a dedicated battery power supply may not provide sufficient power to process data in the cache. In some embodiments, therefore, in an event of power failure for a storage device, processing of cache data and to ensure data consistency and integrity is accomplished without a particular configuration of the hardware or software.

Embodiments of the present disclosure provides a cache data processing apparatus, computer program product and a method which includes monitoring power supply statuses of a storage device to determine whether a power failure occurs (hereinafter referred to as “happens”). In a further embodiment, in response to determining that a power failure happens, sending a power failure event to a processor of a storage device such that the processor stops data reading/writing operations of the storage device and flushes a cache data to a disk.

According to one embodiment, the method may further include monitoring, by an Intelligent Platform Management Interface (IPMI), power supply statuses of a storage device. According to another embodiment, the method may include determining whether a power failure happens according to a combination of a power supply status of two or more power supplies. According to yet another embodiment, the method may include connecting two or more power supplies to monitor by an IPMI a power supply status of the two or more power supplies simultaneously.

According to one embodiment, the method may further include determining that no power failure happens when an external power supply is switched on and an Uninterruptible Power Supply (UPS) is switched on. A further embodiment may include determining that a power failure happens when an external power supply is switched off and a UPS is switched on. A further embodiment may include determining that no power failure happens when an external power supply is switched on and a UPS is switched off. According to another embodiment when an external power supply is switched on and a UPS is switched off, an administrator of a storage device may be notified to maintain an uninterrupted power supply. According to another embodiment the method may further include using a UPS to supply power to a storage device in the event of a power failure.

According to one embodiment, the method may further include determining a cache data that has not been flushed in a disk when a processor stops data reading/writing operations of a storage device. According to another embodiment the method may further include marking a status of a storage device as flushed after flushing a cache data to a disk. According to yet another embodiment the method may further include continuing new data reading/writing operations according to a status of a storage device that may have been marked as flushed when power supply restores.

According to one embodiment, a cache data processing apparatus may include a monitoring unit configured to monitor power supply statuses of a storage device to determine whether a power failure happens. In a further embodiment, the apparatus may include a power failure response unit configured to send a power failure event to a processor of a storage device in response to determining that a power failure happens such that a processor stops data reading/writing operations of the storage device and flushes cache data to a disk.

According to one embodiment, the monitoring unit may be further configured to monitor, by an Intelligent Platform Management Interface (IPMI), a power supply status of the storage device. According to another embodiment, the monitoring unit may be further configured to determine whether a power failure happens according to a combination of power supply statuses of two or more power supplies. According to yet another embodiment, the apparatus may include a connecting unit configured to connect two or more power supplies in order to monitor by an IPMI, power supply statuses of two or more power supplies simultaneously.

According to one embodiment, a monitoring unit may be further configured to determine that no power failure happens when an external power supply is switched on and an Uninterruptible Power Supply (UPS) is switched on. A further embodiment may include determining that a power failure happens when an external power supply is switched off and a UPS is switched on. A further embodiment may include determining that no power failure happens when an external power supply is switched on and UPS is switched off.

According to another embodiment, a monitoring unit may be further configured to notify an administrator of a storage device to maintain an uninterrupted power supply when an external power supply is switched on and a UPS is switched off. According to yet another embodiment, a power failure response unit may be further configured to use a UPS to supply power to a storage device in the event of a power failure.

According to one embodiment, a power failure response unit may be further configured to determine cache data that has not been flushed in a disk when a processor stops data reading/writing operations of a storage device. According to another embodiment, the apparatus may include a marking unit configured to mark a status of a storage device as flushed after flushing cache data to a disk. According to yet another embodiment, the apparatus may further include a restoring unit configured to continue new data reading/writing operations according to a status of a storage device that may have been marked as flushed when power supply restores.

According to one embodiment, a computer program product may include computer readable program instructions embodied therein, when instructions are executed by the processor, the instructions cause the processor to perform cache data processing as disclosed herein.

In one advantageous embodiment, power supply statuses of a storage device may be monitored actively. In another advantageous embodiment, it may be determined whether power failure happens according to a combination of power supplies. In a further advantageous embodiment, a UPS may be used as a power supply to flush data in a cache when a power failure happens, and extra data processing time for a storage device may be provided. In a further advantageous embodiment, consistency and integrity of data in a storage device may be effectively ensured in the event of a power failure. In a further advantageous embodiment, since it is unnecessary to load cache data from a non-volatile storage area after power supply restores, starting time of a storage device system may be significantly reduced.

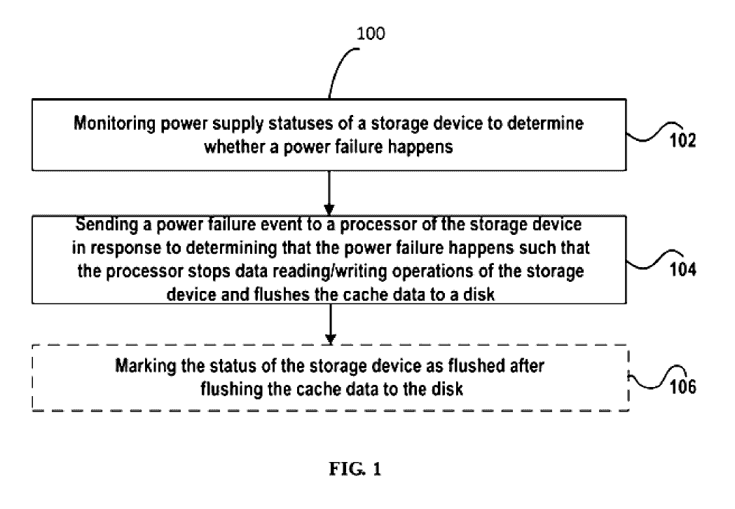

Reference is now made to FIG. 1, which illustrates a flow diagram of the cache data processing method 100 according to the embodiments of the present disclosure. With reference to FIG. 1, at step 102, a power supply status of a storage device is monitored to determine whether a power failure happens. At step 104, a power failure event is sent to a processor of the storage device in response to determining that the power failure happens such that the processor stops data reading/writing operations of the storage device and flushes cache data to a disk. At the step 106, the status of the storage device is marked as flushed after the cache data is flushed to the disk. For instance, the cache data is marked as “flushed” “cleaned” or “processed”, which means that it is unnecessary to flush the cache data in the non-volatile storage area in the event of power failure.

With reference to Step 102, in an example embodiment, it may be determined whether one or more power supplies of a storage device works normally in order to determine whether the storage device has a power failure by obtaining a power supply status of the storage device actively and in real time with software, such as with one power supply status and a combination of a plurality of power supply statuses. In one embodiment, a power supply status of a storage device may be monitored by an Intelligent Platform Management Interface (IPMI). IPMI is an abbreviation of Intelligent Platform Management Interface and represents an industrial standard for peripheral devices for managing various systems. In one embodiment, IPMI is an interface specification for hardware management with open standard, which may detect a status of hardware connected therewith independently. In an example embodiment, physical healthy features of storage devices, such as temperature, voltage, and power supply status may be monitored. In a further embodiment, since IPMI connects hardware instead of software, it may work independently of the operating system. In another embodiment, an existing IPMI as well as software (such as IPMITOOL, FreeIPMI and IPMIUTIL) may be utilized to monitor power supply statuses of a storage device.

In one embodiment, it may be determined whether a power failure happens according to a combination of statuses of two or more power supplies. In an example embodiment, for a storage device having a disk array, power supplies with a number of two or more than two in even number may be inserted. In a further embodiment, a power supply status of a storage device may be determined by detecting a combination of the statuses of a plurality of power supplies, in order to determine whether a power failure happens. In an example embodiment, if there are N power supplies, a combination of power supply statuses may be 2̂N in number, wherein N is an even number of two or more. In a further embodiment, for instance, when N is 2, four combinations of power supply statuses may exist.

In one embodiment, two power supplies may be inserted on a storage device, which may run in an active-active mode (namely, two power supplies run simultaneously) or active-passive mode (namely, two power supplies run alternatively). In one embodiment, method 100 may further include connecting two more power supplies (e.g. by cable connection) to monitor by the IPMI, power supply statuses of the two or more power supplies at a same time. In a further embodiment, for instance, two power supplies may be monitored simultaneously by IPMI. In a further embodiment, for each electronic element in a storage device, two power supplies may share power supply distribution. In a further embodiment, when one power supply has a power failure, the other power supply may continue to supply power to a storage device.

In a further embodiment, two power supplies may be inserted on a storage device, wherein one power supply may be connected to the external power supply (e.g. mains supply), and the other power supply may be connected to an uninterrupted power supply (UPS) which may be further connected to the external power supply. In this embodiment, a power supply is configured as redundant while a storage device can work on a single power supply. In a further embodiment, even if am external power supply is switched off due to power failure, UPS may still supply power to a storage device for an amount of time.

In one embodiment, method 100 may further include determining that no power failure happens when an external power supply is switched on and a UPS is switched on. A further embodiment may include determining that a power failure happens if an external power supply is switched off and a UPS is switched on. A further embodiment may include determining that no power failure happens if an external power supply is switched on and a UPS is switched off. In an example embodiment, when both external power supply and UPS work normally, power supply is in normal operation and then no action should be taken. In a further embodiment, when external power supply is switched on while UPS is switched off, it may imply that external power supply functions normally while UPS has a power failure. In a further embodiment, an administrator of a storage device may be notified to maintain a UPS. In a further embodiment, when an external power supply is switched off while a UPS is switched on, it may imply that external power supply has power failure and a storage device enters a power failure mode. In a further embodiment, a UPS may take on a power supply of a storage device and supply extra power to the storage device for an amount of time. In a further embodiment, a system generates a power failure event and a processor of a storage device may take corresponding actions in response to the power failure event. In an additional embodiment, when both external power supply and UPS are switched off, it may imply that the two power supplies both have a power failure. In a further embodiment, under such circumstances, battery power may be configured to supply power for a limited amount of time and flush cache data into a non-volatile storage area. In a further embodiment, when external power supply restores, a system of a storage device reads cache data from a non-volatile storage area and performs a corresponding process.

In one embodiment, at step 104, a power failure event is sent to a processor of a storage device in response to determining that a power failure happens such that the processor stops data reading/writing operations of the storage device and flushes cache data to a disk. In a further embodiment, a base board controller (BMC) may send a power failure event directly to a processor of a storage device through IPMI or through other power supply status monitor module. In a further embodiment, after receiving a power failure event, a processor stops all data reading/writing operations or I/O operations of a storage device immediately, and the processor may be configured to flush cache data to a disk after determining that all data reading/writing operations or I/O operations have been stopped. In disclosure further embodiment, cache data may refer to dirty data that has been loaded into a cache but not been written to a disk. In a further embodiment, presence of dirty data may lead to inconsistency or incompletion of data storage of a storage device.

In one embodiment, method 100 may further include using a UPS to supply power to a storage device in case of a power failure. In a further embodiment, a UPS is an apparatus that may be configured to supply emergency power when an external power supply, e.g., mains supply, has a power failure. In a further embodiment, a UPS may supply power to a storage device continuously with an inverter by replacing an external power supply with its internal battery quickly when main power supply fails.

In a further embodiment, power supply time of a UPS may be configured from several minutes to a couple of hours based on actual needs. In a further embodiment, power supply capability of a UPS may be much larger than a battery power supply in an existing storage device. In a further embodiment, in an event of power failure, a UPS may provide extra operating time to process data in a cache.

In one embodiment, method 100 may further include determining cache data that may not have been flushed in a disk after a processor stops data reading/writing operations of a storage device. In a further embodiment, after determining that a power failure happens, cache data that may not have been flushed in a disk (namely, dirty data in a cache) may be determined while a processor stops data reading/writing in order to flush cache data to a disk.

In one embodiment, at step 106, a status of a storage device may be marked as flushed after cache data is flushed to a disk. In a further embodiment, for instance, cache data may be marked as “flushed” “cleaned” or “processed”, which means that it may be unnecessary to flush cache data in a non-volatile storage area in the event of a power failure. In a further embodiment, after a UPS power supply disappears, it may be unnecessary to further process cache data.

In one embodiment, after power supply restores, new data reading/writing operations may be continued to be processed according to a status of the storage device that may have been marked as flushed. In a further embodiment, after a power supply restores, according to a status of a storage device that has been marked as flushed, it may be unnecessary to load cache data from a non-volatile storage area since cache data may have been flushed in a disk. In an advantageous embodiment, starting time of a storage device system may be significantly reduced.

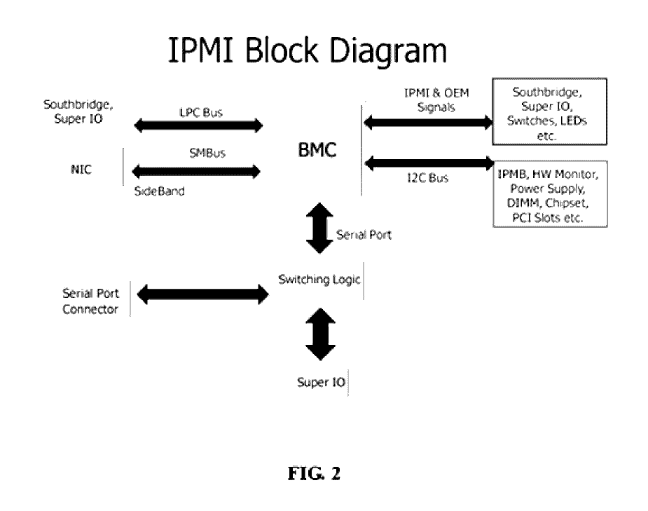

Reference is now made to FIG. 2, which illustrates a block diagram of the intelligent platform management interface (IPMI) 200 according to one exemplary embodiments of the present disclosure. As shown in FIG. 2, IPMI is mainly implemented with a based board management controller (BMC), and IPMI may obtain from BMC hardware information of components (e.g. power supply, network adaptor, Southbridge I/O chip) connected therewith. BMC generally may have the following functions: accessing through a serial port of a system, recording breakdown log, and sending SNMP alarm, accessing a system event log (SEL) and a sensor condition, controlling switch on and off independently of a power supply or working condition. Power supply status of a storage device may be obtained in real time by the way BMC monitors a power supply status. BMC may obtain hardware information, such as temperature, voltage and power supply status, of hardware devices connected therewith through a bus, e.g., LPC bus, I2C bus.

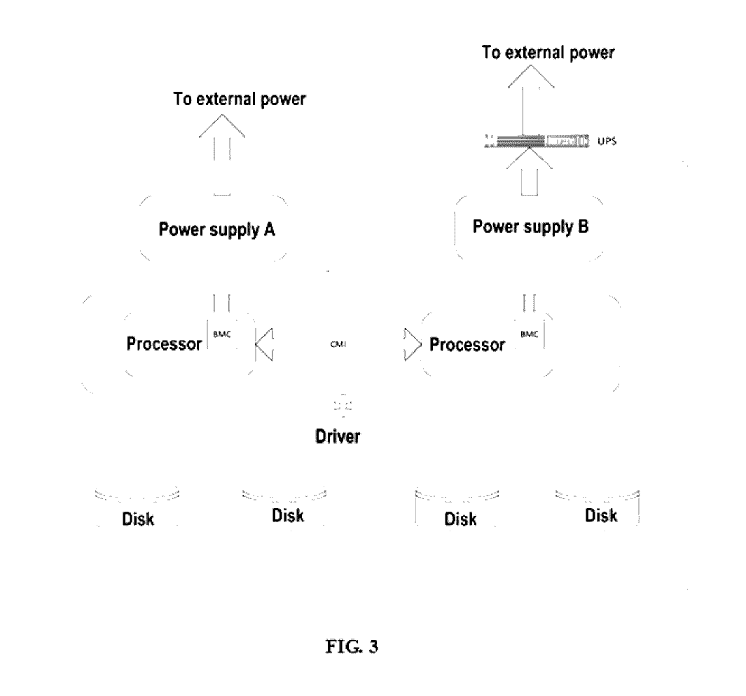

Reference is now made to FIG. 3 illustrates a block diagram of a system 300 of the storage device comprising two power sources according to exemplary embodiments of the present disclosure. System 300 comprises a disk, a driver, a processor, BMC, a power supply A and a power supply B, wherein power supply A is connected to an external power supply (e.g. mains supply) directly and power supply B is connected to a UPS which is further connected to an external power supply. With detection of statuses of power supply A and power supply B, current statuses of power supplies of a storage device may be determined. There are four combinations of statuses of power supply A and power supply B. For example, when both power supply A and power supply B are switched on, it may be determined that no power failure happens; when power supply A is switched on and power supply B is switched off, it may be determined that no power failure happens; when power supply A is switched off and power supply B is switched on, it may be determined that system 300 has a power failure. The system generates a power failure event after BMC determines that a power failure happens through IPMI. When both power supply A and power supply B are switched off, it may be determined that a storage device does not have any available power supply.

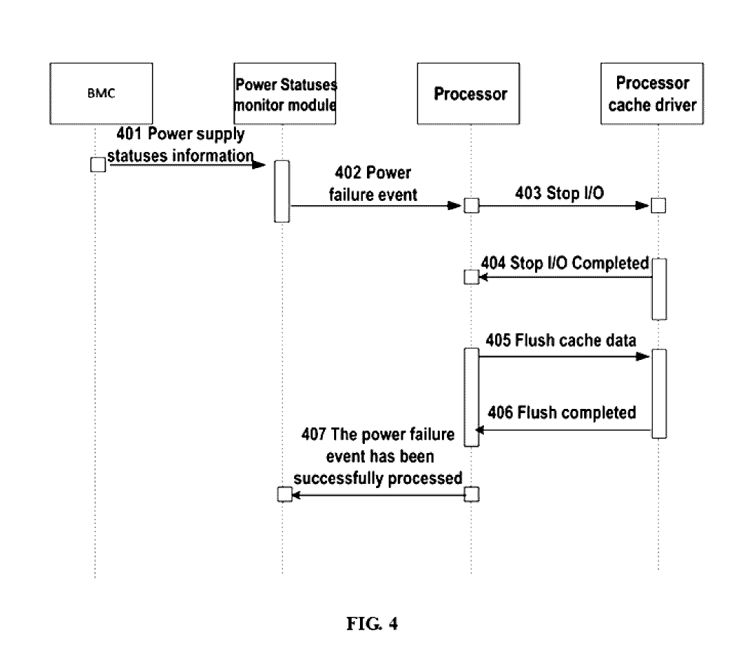

FIG. 4 illustrates a flow diagram of the cache data processing method 400 according to exemplary embodiments of the present disclosure. FIG. 4 includes several components, such as a base board management controller, a power supply status monitor module, a processor and a processor cache driver. In one embodiment, a power supply status monitor module may be configured separately or may be configured inside other components, such as a processor, and BMC may send power failure event to a processor directly.

At step 401, BMC sends a power supply status information to a power supply status monitor module. At step 402, the power supply monitor module sends a power failure event to a processor after determining that a power failure happens. At step 403, the processor sends a command for stopping data reading/writing operations or I/O operations of a storage device to the processor cache driver in response to the power failure event. At step 404, the processor cache driver completes the step of stopping data reading/writing operations or I/O operations. At step 405, the processor flushes data contained in a cache, i.e. dirty data, to the disk. At step 406, the operation of flushing cache data is completed. At step 407, the processor sends to the power supply status monitor module a message that the power failure event has been successfully processed. It should be noted that the processing method presented in FIG. 4 is only an exemplary embodiment, wherein a power supply status monitor module and a processor cache driver may be omitted, or be integrated in other components to accomplish a corresponding function, and some steps may be omitted or altered.

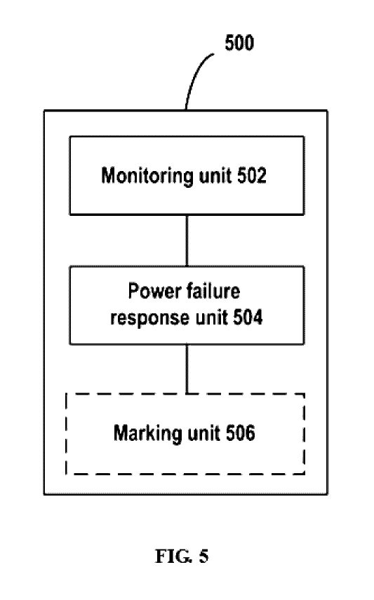

FIG. 5 illustrates a block diagram of cache data processing apparatus 500 according to exemplary embodiments of the present disclosure. Apparatus 500 comprises monitoring unit 502 configured to monitor power supply statuses of the storage device to determine whether a power failure happens. Apparatus 500 further includes power failure response unit 504 configured to send a power failure event to a processor of a storage device in response to determining that a power failure happens such that a processor stops data reading/writing operations of a storage device and flushes cache data to a disk. In one embodiment, apparatus 500 may further include a marking unit 506 configured to mark a status of a storage device as flushed after flushing cache data to a disk.

It should be appreciated that apparatus 500 may be implemented in various manners. For example, in some embodiments, apparatus 500 may be implemented with hardware, software or a combination of software and hardware, wherein the hardware portion may be implemented with a dedicated logic; the software portion may be stored in the memory and the system is implemented with proper instructions, such as implemented with a microprocessor or dedicated design hardware. Those skilled in the art may understand that the above method and system may be implemented with computer-implementable instructions and/or control codes in the storage device, such as disk, CD or DVD-ROM. Such codes are provided in the ROM programmable memory or data carrier of the optical or digital signal carrier. The device and apparatus of embodiments of the present disclosure can not only be implemented with, such as very large scale integrated circuit or gate array, semiconductors such as logic chip and transistors, or hardware circuit of programmable hardware devices such as field-programmable gate array and programmable logic devices, but also be implemented with software implemented by various types of processors and a combination of the above hardware circuit and software.

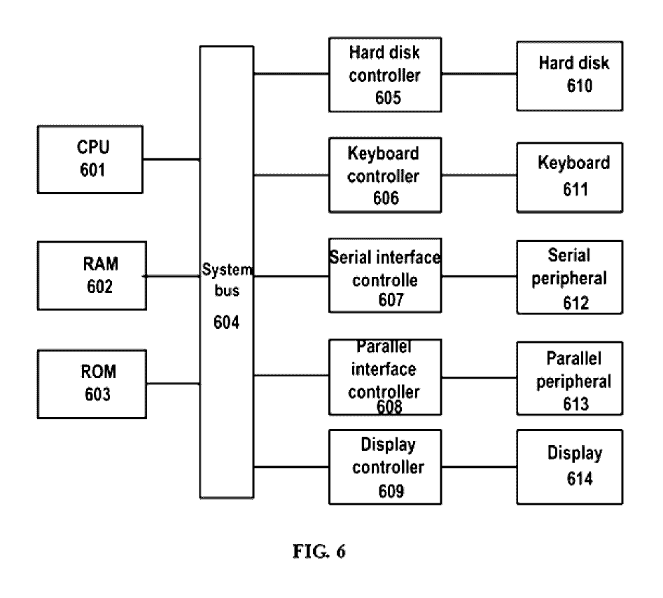

In the following context, a computer device in which embodiments of the present disclosure can be achieved is described with reference to FIG. 6. FIG. 6 illustrates a block diagram of a system 600 in which the computer device according to exemplary embodiments of the present disclosure can be implemented. Computer system includes CPU (central processing unit) 601, RAM (random access memory) 602, ROM (read only memory) 603, system bus 604, disk controller 605, keyboard controller 606, serial interface controller 607, parallel interface controller 608, display controller 609, disk 610, keyboard 611, serial peripheral 612, parallel peripheral 613 and display 614. Among those components, system bus 604 is connected with CPU 601, RAM 602, ROM 603, disk controller 605, keyboard controller 606, serial interface controller 607, parallel interface controller 608 and display controller 609. Disk 610 and disk controller 605 are connected, keyboard 611 and keyboard controller 606 are connected, serial peripheral 612 and serial interface controller 607 are connected, parallel peripheral 613 and parallel interface controller 608 are connected, and display 614 and display controller 609 are connected. It should be noted that the structure block illustrated in FIG. 6 is only shown for the purpose of example rather than to limit the present disclosure. Under some conditions, some devices may be added or deleted according to actual needs.

Embodiments of the present disclosure can be stored in a storage device, such as disk 610, in a computer as computer program codes, which cause CPU 601 to implement the cache data processing method when loaded into the memory.

Embodiments of the present disclosure provide extra data processing time for a storage device by obtaining power supply statuses of a storage device in real time and using UPS to flush data in a cache to a disk in the event of power failure. Thus, embodiments of the present disclosure may effectively ensure consistency and integrity of data in a storage device. After power supply restores, it may be unnecessary to load cache data from a non-volatile storage area, thereby saving starting time of the storage device.

It should be noted that though the detailed description given in the previous context provides several devices or sub-devices of the apparatus, the division is only exemplary instead of obligatory. In fact, features and functions of the two or more apparatuses described above may be embodied in one apparatus according to embodiments of the present disclosure. By contrast, features and functions of one apparatus described above may be divided and embodied in a plurality of apparatuses.

Embodiments disclosed above are only optional embodiments which are not used to limit embodiments of the present disclosure. For those skilled in the art, embodiments of the present disclosure may have various modifications and alterations. Any modification, alternative substitution and improvement should be included within the scope of protection of the embodiments of the present disclosure without departing from the spirit or scope of the embodiments of the present disclosure.

Though embodiments of the present disclosure have been described with reference to several specific embodiments, it should be appreciated that embodiments of the present disclosure are not limited to the specific embodiments of the present disclosure. Embodiments of the present disclosure aim to cover various modifications and equivalent arrangement within the spirit and scope of the appended claims. The scope of the following claims conforms to the broadest explanation and thus includes all the modifications and equivalent structures and functions.

What is claimed is:

1. A cache data processing method, the method comprising:
monitoring power supply statuses of a storage device to determine whether a power failure occurs; and
sending a power failure event to a processor of the storage device in response to determining that the power failure occurs such that the processor stops a data reading/writing operation of the storage device and flushes cache data to a disk.

2. The method according to claim 1, wherein monitoring power supply statuses of a storage device comprises:
monitoring, by an intelligent platform management interface (IPMI), the power supply statuses of the storage device.

3. The method according to claim 1, wherein determining whether a power failure occurs comprises:
determining whether a power failure occurs according to a combination of power supply statuses of two or more power supplies.

4. The method according to claim 3, further comprising:
connecting the two or more power supplies in order to monitor by the IPMI the power supply statuses of the two or more power supplies simultaneously.

5. The method according to claim 3, wherein determining whether a power failure happens according to a combination of power supply statuses of two or more power supplies comprises at least one of:
determining that no power failure occurs when an external power supply is switched on and an Uninterruptible Power Supply (UPS) is switched on; and
determining that the power failure occurs when the external power supply is switched off and the UPS is switched on; and
determining that no power failure occurs when the external power supply is switched on and the UPS is switched off.

6. The method according to claim 5, further comprising:
notifying an administrator of the storage device to maintain the UPS when the external power supply is switched on and the UPS is switched off.

7. The method according to claim 1, further comprising:
on receiving the power failure event at the processor of the storage device using the UPS to supply power to the storage device.

8. The method according to claim 1, further comprising:
determining the cache data not flushed to the disk when the processor stops the data reading/writing operation of the storage device.

9. The method according to claim 1, further comprising:
marking a status of the storage device as flushed after flushing the cache data to the disk.

10. The method according to claim 9, further comprising:
on restoration of the power supply, continuing a new data reading/writing operation according to the status of the storage device marked as flushed.

11. A cache data processing apparatus configured for:
monitoring power supply statuses of a storage device to determine whether a power failure occurs; and
sending a power failure event to a processor of the storage device in response to determining that the power failure occurs such that the processor stops a data reading/writing operation of the storage device and flushes cache data to a disk.

12. The apparatus according to claim 11, wherein monitoring power supply statuses of a storage device is configured for:
monitoring, by an intelligent platform management interface (IPMI), the power supply statuses of the storage device.

13. The apparatus according to claim 11, wherein determining whether a power failure occurs is further configured for:
determining whether a power failure occurs according to a combination of power supply statuses of two or more power supplies.

14. The apparatus according to claim 13, further configured for:
connecting the two or more power supplies in order to monitor by the IPMI the power supply statuses of the two or more power supplies simultaneously.

15. The apparatus according to claim 13, wherein determining whether a power failure happens according to a combination of power supply statuses of two or more power supplies configured for performing at least one of:
determining that no power failure occurs when an external power supply is switched on and an Uninterruptible Power Supply (UPS) is switched on; and
determining that the power failure occurs when the external power supply is switched off and the UPS is switched on; and
determining that no power failure occurs when the external power supply is switched on and the UPS is switched off.

16. The apparatus according to claim 15, further configured for:
notifying an administrator of the storage device to maintain the UPS when the external power supply is switched on and the UPS is switched off.

17. The apparatus according to claim 11, further configured for:
on receiving the power failure event at the processor of the storage device using the UPS to supply power to the storage device.

18. The apparatus according to claim 11, further configured for:
determining the cache data not flushed to the disk when the processor stops the data reading/writing operation of the storage device.

19. The apparatus according to claim 11, further configured for:
marking a status of the storage device as flushed after flushing the cache data to the disk.

20. A computer program product, comprising computer-readable program instructions embodied therein, when executed by a processor, cause the processor to perform:
monitoring power supply statuses of a storage device to determine whether a power failure occurs; and
sending a power failure event to a processor of the storage device in response to determining that the power failure occurs such that the processor stops a data reading/writing operation of the storage device and flushes cache data to a disk.
